(19) United States
(12) Patent Application Publication
(10) Pub. No.: US 2002/0072972 A1
(43) Pub. Date: Jun. 13, 2002

(54) Method and system for delayed advertising

(76) Inventor: Robert G. Lamont, Van Nuys, CA (US)

Correspondence Address: Oppenheimer Wolff & Donnelly LLP, Suite 3800, 2029 Century Park East, Los Angeles, CA, 90067, US

(21) Appl. No.: 09/962,933

(22) Filed: Sep. 24, 2001

Related U.S. Application Data
(60) Provisional application No. 60/234,537, filed on Sep. 22, 2000.

(51) Int. Cl. G06F 7/00; G06F 17/30; G06F 17/60; H04L 9/00; H04L 9/32; G06F 11/30; G06F 12/14

(52) U.S. Cl. 705/14; 713/201

(57) ABSTRACT

An advertisement includes preliminary and delayed content. In one embodiment, the delayed content is registered with delay service. A consumer selects an advertisement and indicates that the delayed content should be flagged. An ad ID is either sent to the delay service or to the advertiser. At a later point in time, the delayed content is made available to the viewer. In some embodiments privacy of the user is protected by the delay service acting as a wall between the consumer and the advertisers. Proxy addresses are maintained by the delay service to request content for the user rather than reveal the user's true address or other data. The delayed advertisement system can be implemented for Internet ads, as well on interactive television, radio, or wireless networks.

### CROSS-REFERENCE TO RELATED APPLICATIONS

This application claims the benefit of U.S. Provisional Application No. 60/234,537, filed on Sep. 22, 2000, entitled “Delayed Advertising System for Computational Commerce.” Applicants incorporate the contents by reference.

### BACKGROUND OF THE INVENTION

This invention relates to the delivery of ads in an interactive networked medium. More specifically, it relates to ads which are presented to a viewer and can be flagged by that viewer so that observing the content of the ad is delayed to a later time.

The new millennium has proved to be the Age of the Internet. The Internet presents advertisers with a new frontier of potentials. However, as a still-maturing form of media, the advertising industry is still learning how best to conquer the Internet.

Currently, most on-line advertising is in the form of banner ads. FIG. 1 is a flowchart illustrating how such banner ads currently operate. Included within this flowchart are advertisers who set up their banner ads 100 and web viewers 140 (Internet surfers) using Netscape, Internet Explorer, or another browser to view a series of web sites. The banner ads either can be incorporated directly into a web page's source code (such as HTML) 105, or the ads can be handled by ad networks 115 who, for any given web page, serve a sequence of banner ads 160. Ad networks may serve certain ads to a viewer of a web site without any correlation between the subject matter of the web site and the ad. Ad networks also may serve only those ads that seem highly suitable to the viewer. For example, they may present advertising based on keywords entered by the user into a search engine. For example, a person searching for information on airline flights may receive advertising for airlines, hotels, rental cars or travel web sites. Regardless, the viewer is presented with a web page that includes one or more banner ads 165. As is commonly known by the user, the banner ad is merely an introduction or pathway to the full advertisement. By clicking on the banner ad 170, the user is either directly 180 or indirectly 190 presented with the full advertisement. But, by doing so, the viewer leaves the web page currently being browsed.

E-commerce and Internet advertising have several current shortcomings. As shown in FIG. 1, the predominant form of Internet advertising is the use of banner ads on web sites. During the busiest times of the year web pages exhibit over seventy billion banner ads monthly. These banner ads serve as a primary source of income for most web sites. Unfortunately, when a banner ad succeeds—i.e., when the Internet user clicks on the banner—the ad draws the user away from the web site, depriving the site of further attention from the user, and a chance for more revenue by the user clicking on a second, or third, banner ad on the web site. Thus, banner ads are often a mixed blessing.

The second common problem with banner advertising on the Internet is that web surfers find banner ads distracting. If any banner ad looks interesting, surfers must leave the web site that they are viewing when they click on the banner ad to receive more details. Alternatively, if the surfer waits until he or she is done with viewing the web site before choosing a banner ad, the particular banner ad may have been replaced since web sites usual display ads on a cycle.

Third, advertisers want banner ads to be more effective. At present, users click on only 1%-2% of banner ads. Some people who would otherwise click on a banner ad choose not to do so because they do not want to leave the web site they are currently visiting. Obviously, advertisers would like to obtain these people as customers.

Privacy is another issue with current Internet advertising methods. As evidence of this, the stock of at least one large eCommerce giant fell when the public learned that the company's business policies were discovered to threaten consumers' privacy. There is a tension between the consumers who desire their privacy (fearing that their personal information will be misused and that they will be deluged by “information” they do not want) and advertisers who want to collect consumer data so that ads can be better targeted in the future.

While the Internet reaches millions of people at any given time, shopping on the web does not provide the same experience as shopping with a friend or group of friends at the mall. No eCommerce provider has developed the technology to solve this shortcoming.

Finally, no web site gives consumers an integrated method of viewing requested advertising information combined with a method for searching and viewing periodically updated, specially targeted ads in a personal account (similar to opt-in e-mail message subscription).

Irrespective of these shortcomings, the Internet and e-commerce industries continue to show strong growth. Therefore, advertisers want some way to reverse the declining effectiveness of banner ads.

### SUMMARY OF THE INVENTION

The present invention allows advertising audiences, when exposed to advertisements, to request that advertising information which is made available later. This functionality helps advertisers overcome the increasing ineffectiveness of banner ads. The present invention provides an information management system that allows users to control the information they submit to others on the web. The invention also protects users' personal data and the information they receive (such as ads, newsletters and emails). Thus, it helps to eliminate unsolicited or unwanted items. The present invention extends consumer opt-in advertising to banner ads, television, radio, etc. The present invention targets ads more efficiently to individual consumers who are surfing the web, watching television, etc. The delayed advertising information can be delivered over a different medium than that used to request the delayed information. In addition, the present invention can be enhanced to link on- and off-line purchasing to advertising.

The present invention provides solutions to the current problems in the industry by:

(a) improving the efficacy of banner ads by allowing viewers with a single click on a symbol to browse expanded ads at a later, more convenient time, rather than ignore these banner ads as a distraction;

(b) providing a better medium for requested ads than is currently available on the web by having ads provided on a web site or ads e-mailed from the site to consumers;

(c ) providing customers with a service enabling them to send information about themselves or their organization with a click of a button, while giving them the option of protecting their identity and privacy, where appropriate;

(d) enabling consumers to shop with another person online;

(e) enabling advertisers to provide ads to individual consumers based on their requests;

(f) enabling consumers to view ads and make purchases at a single site, rather than having to visit multiple sites;

(g) providing businesses and advertisers with demographic information on ad viewers and purchasers made at a web site;

(h) establishing a new information network that will collect purchase information on consumers at on-line locations and conventional stores and link this data with consumers' ad viewing history, thus determining the actual effectiveness of ads and enabling performance-based ad pricing, ad-targeting based on purchase history, rebates and the completely electronic coupon, along with other information applications; and

(i) expanding individual-targeting ads to television and radio.

### BRIEF DESCRIPTION OF THE DRAWINGS

FIG. 1 is a flowchart illustrating how such banner ads operate in the prior art.

FIGS. 2A-2C illustrate a three-part flowchart showing in detail one embodiment of a delayed banner system.

FIG. 3 is a flowchart showing generally how the content and information requests flow for a delayed ad.

FIG. 4 illustrates three possible ways in which a delayed advertising system could be implemented.

FIGS. 5A and 5B show two embodiments ways in which the delayed ad technology could work with interactive television.

FIG. 6A is a flowchart illustrating how personal data is protected in the prior art.

FIG. 6B is a flowchart illustrating how the present invention protects personal data while delivering content.

FIG. 7 illustrates the steps for the present invention's ID submission and protection service.

FIG. 8 shows various ways that revenue can flow in the delayed ad system of the present invention.

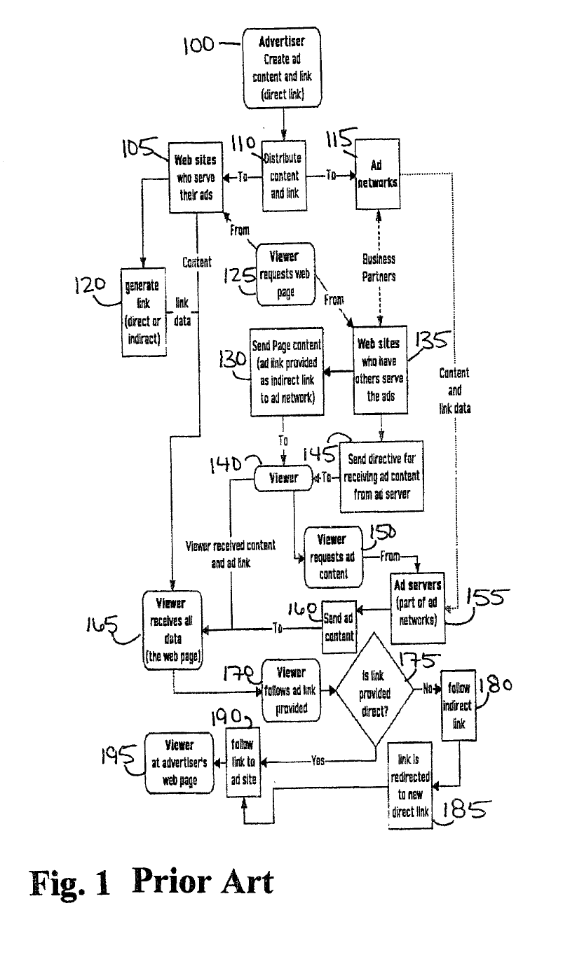

### DETAILED DESCRIPTION OF PREFERRED EMBODIMENTS OF THE INVENTION

### Overview of the Delayed Advertising System

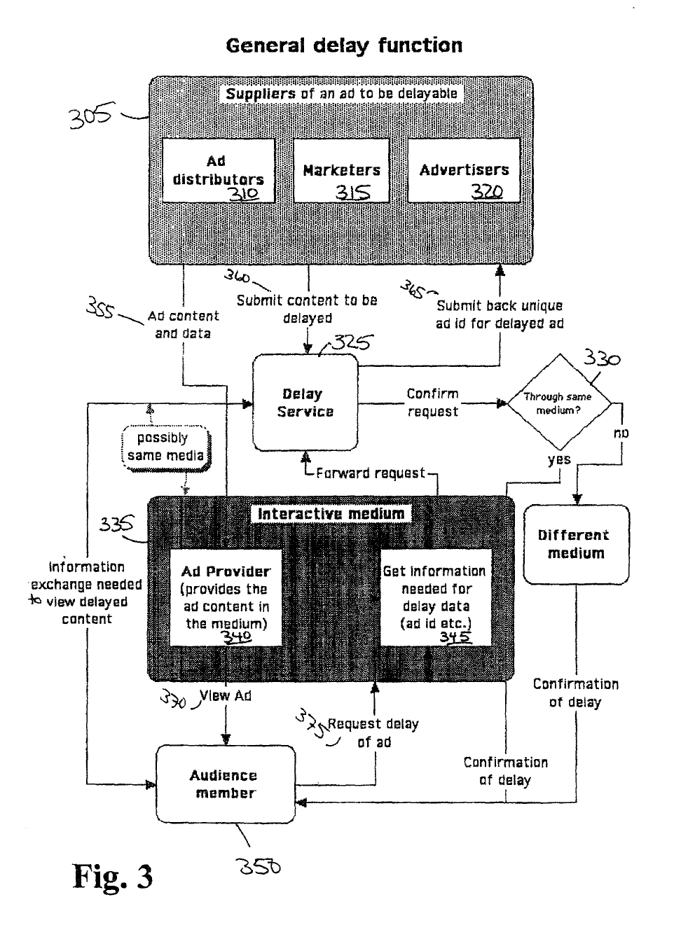

The present invention provides delayed advertising. FIG. 3 is a high level flowchart of how content and information requests interact for such a general delayed ad. Advertisers, 320, marketing companies 315, ad distributors 310 and the like make up the pool of suppliers of the delayed ads 305. Delayed ads have two elements: (1) the portion of the ad directly presented to the audience member 355; and (2) the portion of the ad that is delayed 360 and presented to the audience member at a later point in time.

The audience member 350 accesses some type of interactive medium 335. The Internet is the most common interactive medium now. The process of FIG. 3 can be implemented in any type of medium, Internet, interactive television, interactive cell phone environment, etc. From time to time, the medium presents advertisement 370 to the audience member. The audience member can choose affirmatively to receive, at a later time, supplemental information concerning the advertisement 375. A delay service 325 coordinates the process by which the user receives the delayed advertising content. The user receives the content through the same medium or a different medium 330. A later time has several meanings. It can mean a later transaction wherein a user may visit a web site associated with the delay service in order to retrieve previously flagged delay ads. It also may mean a user-selected time period. For example, a user may desire all flagged, delayed content to be emailed to him or her on Monday morning.

### Web Banner Ads as Delayed Advertising

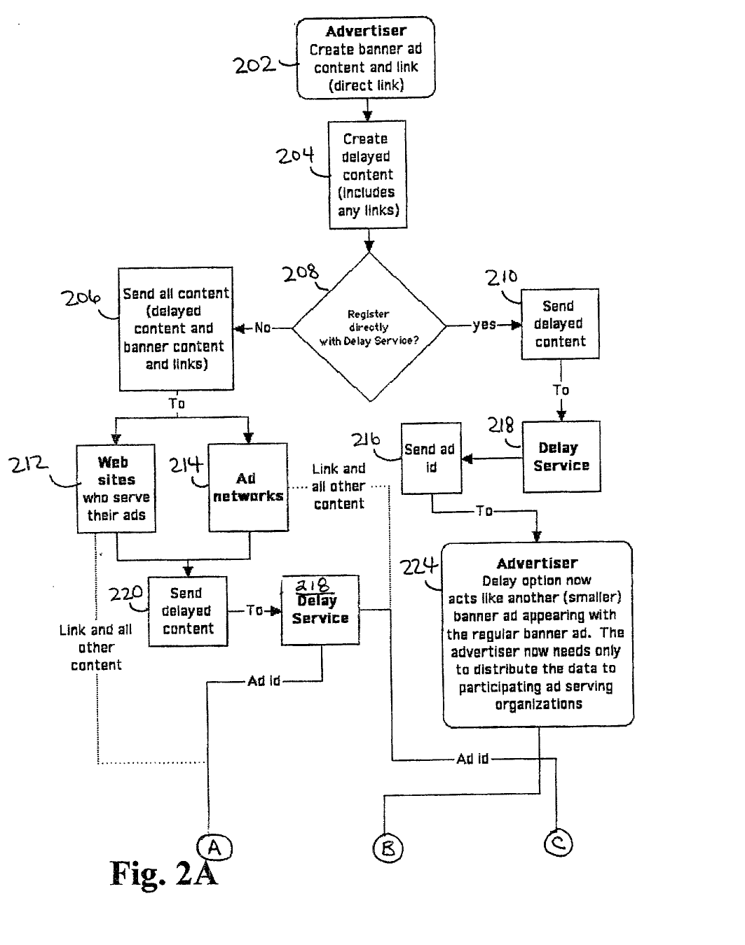

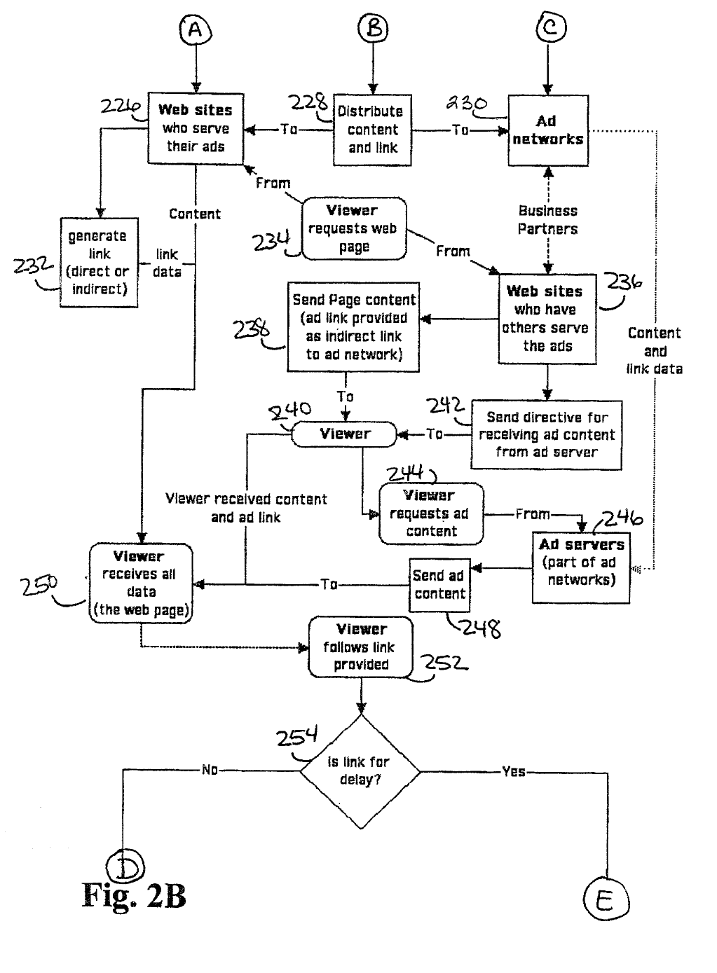

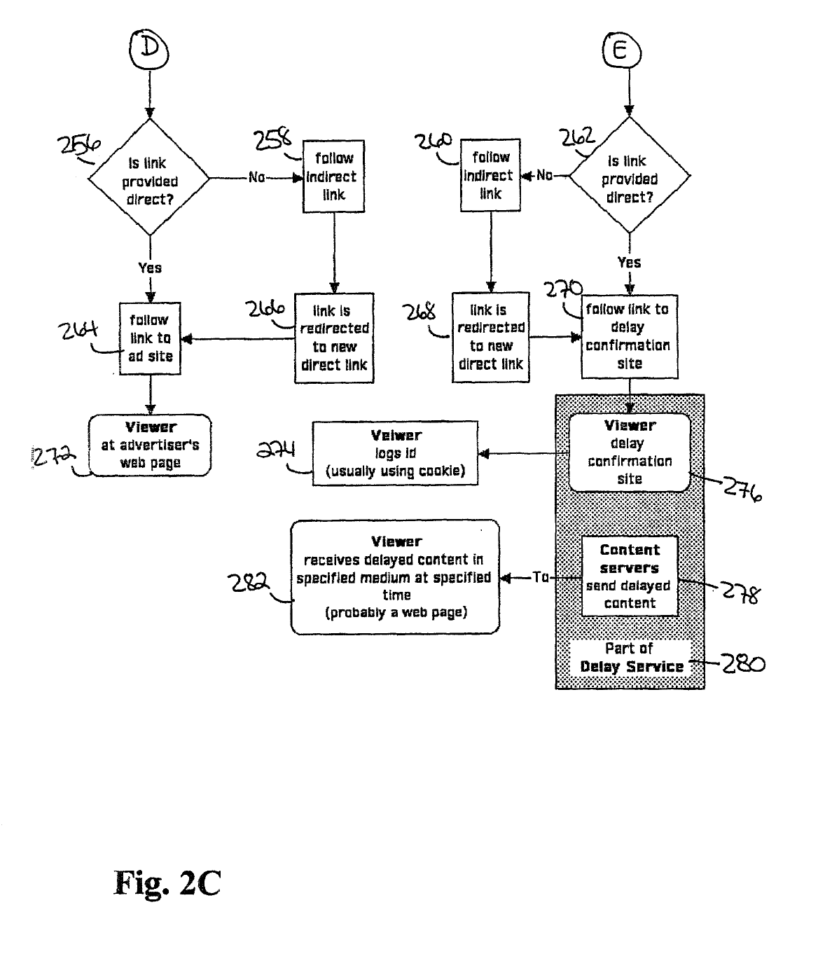

FIGS. 2A-2C are a three-part flowchart showing in detail one embodiment of a delayed content system. In this embodiment, it is implemented on the Internet for providing delayed banner ads. The first part of the process involves advertisement registration. For an advertisement to have the option of being delayed, it must have content to be provided at a later time. An advertiser 202 must provide the content 204 to the service providing the delayed advertising. In addition, a method for naming advertisements with ad IDs must be established.

The advertiser may register with a delay service directly 208,210,218, or may send all of the content to web sites 212 or ad networks 214, who will in turn work with the delay service 218. In order for the delayed advertising to process correctly, the naming convention and unique ad IDs must be used and made available to all these parties. Once the delayed ads are registered, they are available for use.

At some time, a consumer logs onto the Internet and uses a web browser to view a series of web sites. When the viewer requests a certain web page 234, advertising content is included as part of the web page displayed to the viewer. This content can be provided by ad networks 230 and ad servers 246, or the web site's server can generate this content directly 226.

The advertisement displays its regular content to the viewer on the web page 250. The present invention still can display conventional banner ads shown within the web page as well. Thus, for any given web page served to the viewer, some of the banner ads function normally and when selected cause the viewer to be transported to another web site to be shown the rest of the advertisement. Other banner ads on the page are of the new delayed ad type. They allow the user to view the rest of the advertisement at a delayed time.

At his or her discretion, the viewer may select any of the banner ads on the web page 252. If the banner ad chosen is of the traditional type, then the link is not for delay 254. Either the indirect link 258 or the direct link 264 is followed to the advertiser's web page 272. However, if the banner ad chosen supports the delayed functionality 254, then a delay confirmation 270 stores data on the viewer's PC using cookies or other technology 274 so that the viewer can at a later time view the delayed advertisement. In this way, the viewer can continue viewing the current web site. He or she can continue viewing other web sites, all the while also selecting other delayed banner ads. Later, perhaps at the end of the viewer's web surfing or even on another day, the viewer can indicate that he or she wishes to see the delayed content from the ads previously chosen. The delayed content is then presented to the viewer 282 as web pages in a different medium. The viewer can request to see just one of the delayed ads, all of the stored delayed ads, or any combination of the delayed ads. The delay service 280 handles the distribution of this delayed content to the viewer.

As FIGS. 2A through 2C show, the delay service 218 (also referred to as 280) is a central component to the workings of the present invention. The delay service receives the requests from web viewers. The delay service uses the ad IDs and other data structures to identify the original advertisement and which web viewer is requesting the delayed advertising. The delay server optionally may track historical data such as when and where the advertisement was viewed on the Internet by the viewer. The data may arrive at the delay service either by an web user's direct interaction or through a relay that sends and possibly generates the data. The delay service then makes the delayed advertising available to the web user.

### Implementations of Delayed Banner Ads

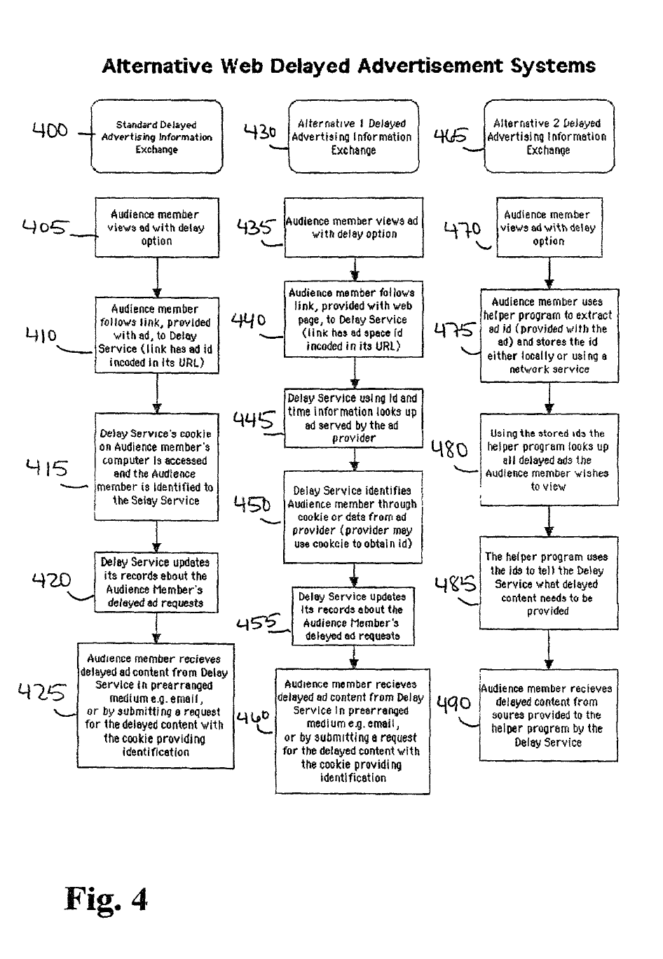

FIG. 4 illustrates three possible ways in which a delayed advertising system could be implemented in the embodiment using banner ads on web pages. The standard system 400 requires a simple web browser capable of storing cookies 415. In this embodiment, the user 415 views ads having delayed functionality 405. The user selects the banner ad and follows the link to the delay service 410. Using cookies, the delay service identifies the user and updates the cookie data about the new request for delayed advertising 420. The delayed content is provided to the user in various ways at a later time 425. For example, an e-mail message can be sent to the user. Alternatively, the user could visit the delay service which uses web site and cookie information to display the appropriate delayed content. The cookie system could be exchanged with another information storage or identification system. For instance, a user might be prompted for a user name and password instead of having the information read from a cookie.

A second system 430 illustrates a similar system. However, system 430 stores the needed data in an alternative method. In this embodiment, the users view the ad that has delayed content associated with it 435. The audience member selects the ad and, thus, follows the link to the delay service 440. Using the ad ID and other information (such as the time), the delay service finds the ad which was served 445. Again, cookie or other data identifies the user 450. The delay service stores in a database the delayed ad request 455. The delayed content is presented to the user at a later time 460.

In the third embodiment, user 465 uses a helper program in addition to the standard web browser. This helper program extracts the ad ID, and either stores the ID locally or uses a network service 475. The helper program then retrieves the desired delayed content 480-490.

The present invention can be implemented using any of a number of computer technologies. For example, in one embodiment which delivers delayed ad content over the Internet, the delay service can be written in Java. The ad content, delayed content, and identifiers can be stored and manipulated in an Oracle or other database.

### Advantages to the Delayed Advertising System

The delayed advertising system of the present invention has many advantages, including the following.

The consumer will appreciate the delayed service according to the present invention because they do not need to interrupt web site viewing to pursue attractive banner ads. Consumers are able to find more information about the products and services advertised in banner ads they select when it is convenient. Moreover, the service also allows the consumer to view many different selected ads. This creates a better shopping experience.

Advertisers will appreciate the delayed banner ad viewing service because the public will ignore fewer banner ads. With the present invention, a portion of the ads currently being ignored will attract customers who are not interested in an immediate click through. They will pursue the ad on a delayed basis, however, which makes the ad more effective in attracting customers. Customers can still click through to advertisers from the delay service web site when viewing delayed ads. They also may make purchases without the additional click through if the advertisers choose this option. Customers can, of course, still click on banner ads to go to the advertiser's web site immediately. The delayed service does increase the options and effectiveness of ads.

With the delayed viewing option, organizations having web sites that host ads will be able to keep viewers at the sites. The viewers may see more ads, enabling the web sites to continue to attract advertisers to support the sites. In addition, web sites (and/or an advertising distribution network) may receive a commission on the delayed banner viewing ad revenue.

By making available a shopping cart function, the delay service allows the user to purchase advertised goods or services when the delayed advertisement is viewed.

Consumers will appreciate the personalized service since on the same site they view the delayed banner ads they have requested, they may also request ads for their local area, for the region, or nationally. Consumers will be able to select ads by various categories, such as product/service type, name brands, new products, and sales. They can interact with other consumers in many ways, such as recommending ads to friends, rating products and services, and seeing what other consumers with similar interests have found worth viewing. They may also receive suggested ads, based on their interests and purchases in a noticeable, but non-intrusive manner. The users are able to request that certain ads be provided to them on a regular schedule through various methods (such as by e-mail).

Advertisers will benefit from the delayed ad service because they only pay for ads that are seen by interested consumers—their products and services are being suggested to other consumers.

### Delayed Ads on Interactive Television

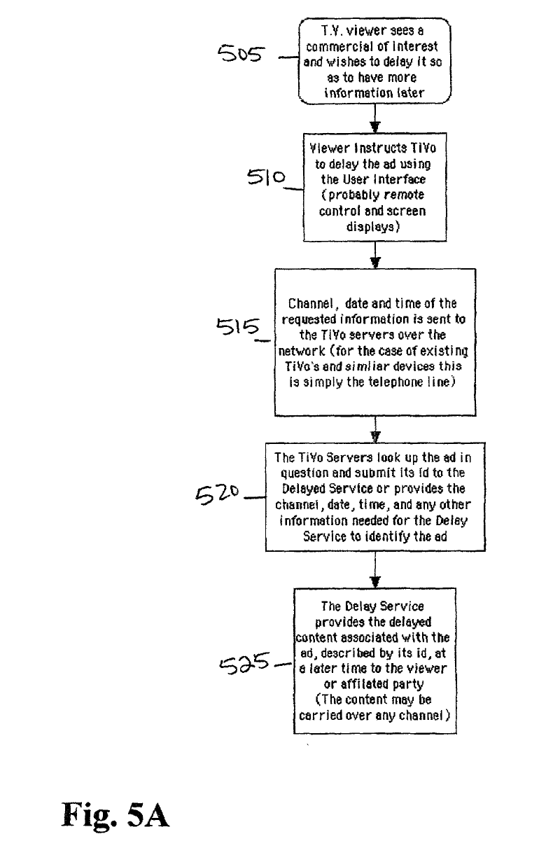

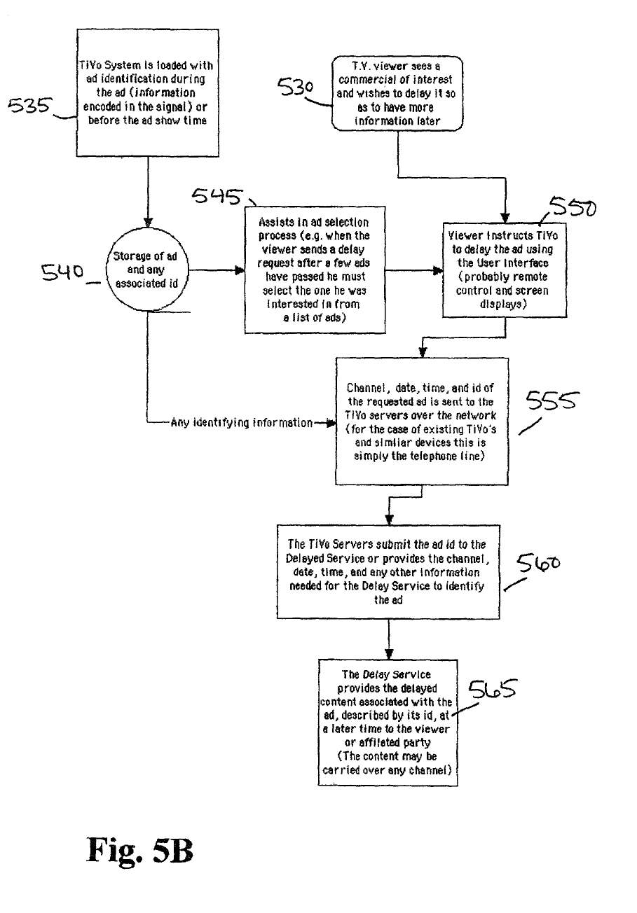

FIGS. 5A and 5B show two embodiments of ways in which the delayed ad technology could work with interactive television. For example, the system could use a networked set top box, such as Tivo. TiVo is a set-top box which acts as a replacement to the VCR by recording television data on an internal hard disk. The system uses a PowerPC architecture with a modified Linux kernel for an operating system.

FIG. 5A shows that a person watching television may see an ad in which she wants delayed information 505. The viewer can send a command to the set top box to delay the ad 510. Data identifying the ad (such as date, time, and channel) is captured and stored 515. Using this data, the ad ID is sent to the delay service 520 for later accessing 525. Of course, in enhanced services, the ad ID could be embedded within the television ad itself so that the ad ID can be determined directly rather than triangulated from the channel, time and date.

In the alternative embodiment shown in FIG. 5B, the viewer watching television 530 may choose an ad having delayed content 550. As with all delay services, the ads that originate the request for delayed advertising must be registered before hand. The registration includes the delayed content as well as ids to associate the delayed content with the original ads 535 and 540. A method for selecting an advertisement to be delayed is provided, such as a special button on the remote control or a software enabled button on the graphical user interface 550. Once an advertisement is selected, the TiVo system relays the proper information to the servers 555. The information includes when and on what channel the ad appeared, thus identifying it, and the ID for the audience (possibly with many individuals in the audience, for example an id for a family).

After the servers receive the information, they pass the information to the delay service 560. The delay service can then provide delayed advertising content in a variety of media, including web pages, email and, as technology and demand dictate, video 565.

### Group Shopping

With certain enhancements to the basic system, the present invention allows social/group shopping online, combining the social experience of chat rooms and online messengers with the shopping cart and advertising technology already developed for Internet commerce. Consumers who like the opinions of others while they shop will really enjoy the ability to chat with their friends as they view ads and make purchases. Furthermore, advertisers will be glad to attract customers who may have avoided online shopping in the past because of the social isolation associated with it.

### Privacy Protection

While the Internet has figuratively brought the world into each person's house, Internet users are very concerned about their privacy while online. Stephen F. Dull, a partner in Accenture's Customer Relationship Management group recently reported on the results a project undertaken by his group in which nearly 10,000 online consumers as well as more than 800 business-to-business buyers were surveyed. Mr. Dull's findings show that across all segments, consumers expressed strong concerns about the privacy of personal information, and that in some consumer segments, businesses can build a better reputation by fully respecting the privacy of their customers by collecting no personal information at all. Mr. Dull's findings are available on the Accenture web page under the “Outlook On-line” section.

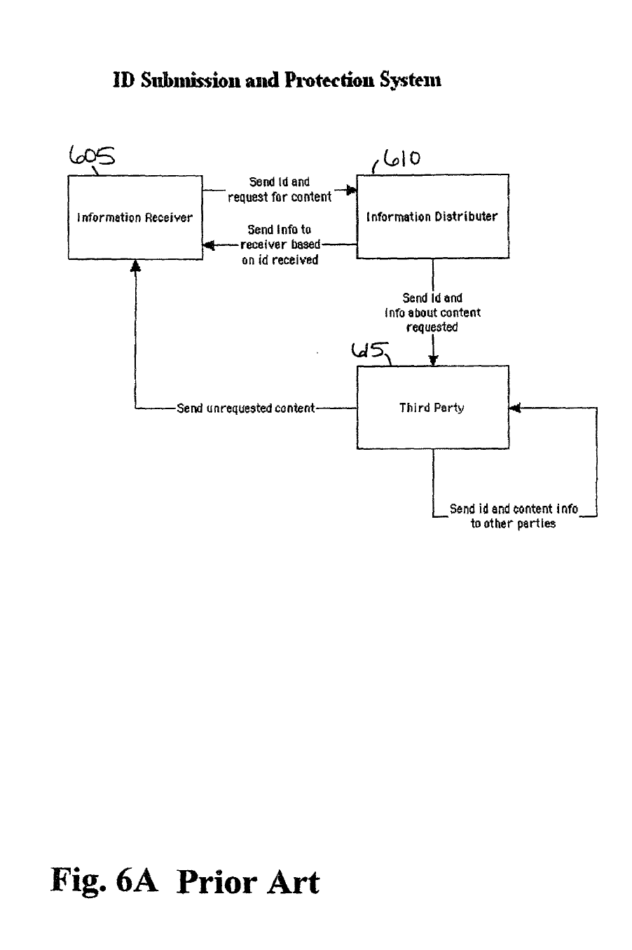

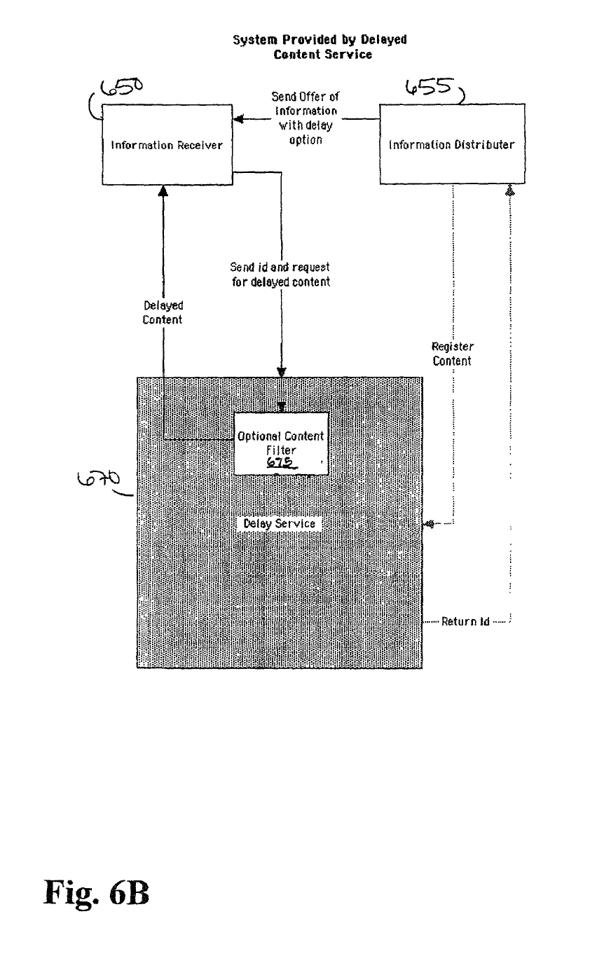

FIG. 6A illustrates the prior art privacy problem that exists today. As any online customer has experienced, the customer 605 can easily requests information about a product or service from an information distributor 610. Unfortunately, such a transaction results in a loss of control over the customer's e-mail address and other personal information. The information distributor 610 often discloses the personal information —often for revenue —to a third party 615, who then either sends the consumer unrequested content, or in turn sells the user's e-mail address to other third parties, which continues this process of the consumer being flooded with unrequested content. Customers are thus becoming less likely to part with their personal data. Of course, advertisers lose marketing revenue once consumers stop requesting information.

FIG. 6B illustrates how the delayed ad system of the present invention has the inherent functionality to protect personal information while delivering content. The system can even be extended to provide privacy protection to physical objects as well as information content. As shown in FIG. 6B, the consumer surfing the Internet 650 can select on an ad banner which supports the delayed advertising of the present invention. The delay service 670 keeps the user's personal data secure and requests from the information distributor 655 the delayed content. At a later point in time, the user 650 can request and view the delayed content through the delay service 670. Optionally, the content can be filtered 675 by the delay service. As long as the single delay service 670 keeps the personal id secure, the consumer can easily view any content delayed banner ad without concern that the consumer's e-mail address and other data is being collected by numerous web sites.

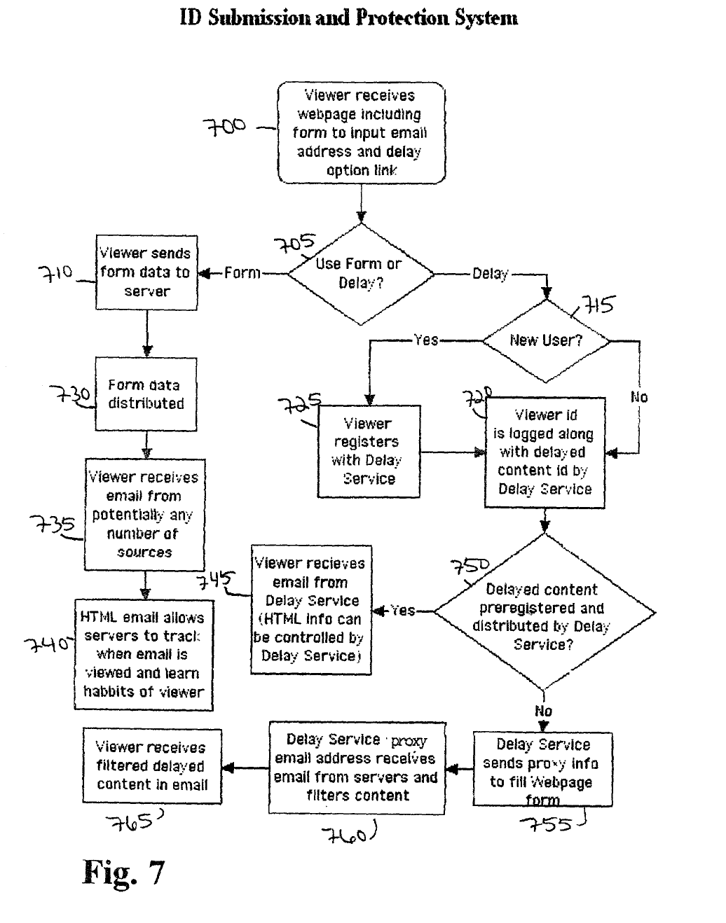

FIG. 7 shows the steps for the present invention's ID submission and protection service. As discussed above, when placing a purchase online, or in another forum where the purchase must be delivered, the address for the delivery must be given. However, the ID protection system of the present invention can be configured so that it translates the user's e-mail address to a proxy address. The delay service can be used to maintain such proxy addresses and to translate them back to the user's true address.

This system allows Internet users to submit information about themselves to businesses and other individuals. The system allows users to control what information they disseminate to others and allows them to use proxies to send and receive information without revealing their full identity. This system allows users to subscribe to email ads or newsletters without subjecting them to unwanted emails. The present invention tracks what information has been submitted to whom and allows users to view and control their information. Through the use of the present invention, consumers benefit from having information concerning their identity and personal choices kept private where appropriate.

Referring to FIG. 7, an example flow of an e-mail letter requested through a web site is shown. The viewer receives an invitation to subscribe to an e-mail letter from a web page 700. The user can choose to fill in the form to receive the e-mail or can delay the content 705. If the user chooses to fill in the form, the form data is sent to the server 710 and is distributed 730. The viewer will then receive one or more e-mail messages pertaining to the subject at hand 735. This can be accomplished via the proxy addresses discussed above, and Managed by a module of the present invention. In this way, the user can, for example, fill in a form indicating an upcoming trip to Costa Rica. The user's e-mail address can remain secure and the various hotels and tour operators in Costa Rica can send e-mail information to the user via the proxy address 765. The user can configure the present invention to disable the proxy address at any time. An added benefit of this type of form server is that the hotels and tour operators, for example, can track the e-mail messages sent to various consumers and use data mining techniques to analyze the effectiveness of the advertising and content 740.

Alternatively, rather than filling out a form, at step 705, the user can choose the delay option 715. The delay service logs the user's ID along with the ID of the content which is to be delayed 720. If the user has not used the delay service before, then the user also must register with the service 725. If the delayed content is already registered with the delay service 750 then it can be sent via e-mail or otherwise to the viewer 745. Otherwise, the delay service can use a proxy to fill in the web page's form 755. The content provider sends the content back to the delay service using the proxy address 760 and then the filtered content is sent to the user 765.

### Demographic Data

In addition to status-of-account reports available immediately on demand, business and advertiser customers can receive useful demographic information and consumer feedback from the services of the present invention. These business customers appreciate receiving the information that enables them to target consumers more effectively. No other site allows businesses and advertisers to receive consumers' comments about ads' strengths and weaknesses. Consumers will be able to voice their approval or disapproval for advertising. Internet feedback, already very popular for many products and services is thus extended to the realm of advertising.

### Revenue Flow

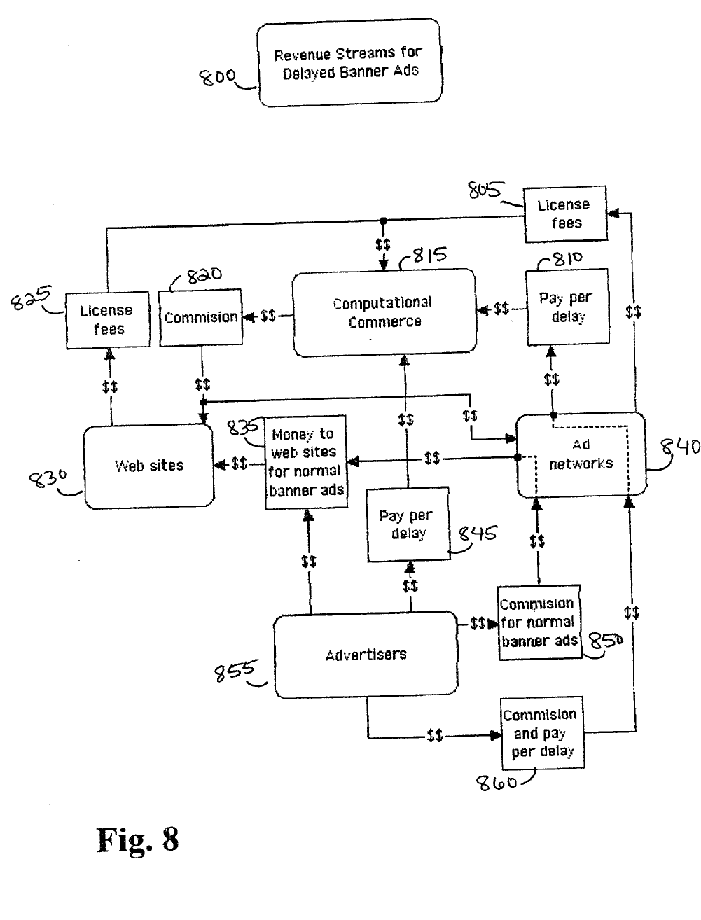

FIG. 8 shows various ways that revenue can flow in the delayed ad system of the present invention. The present invention (aka Computational Commerce) 815, web sites 830, advertisers 855, and ad networks 840 interact with a variety of revenue streams when the present invention's method of presenting delayed ad content to consumers is used. Revenue includes license fees 825 and 805, commission for normal banner ads 850, commissions for delayed content 860, etc.

### Other System Enhancements

The present invention can also have several enhancements built into it which extend its functionality, including the establishment of the Information Network, linking off-line stores' computers (and cash registers) and e-commerce servers with the present invention, is useful to businesses and consumers through its tracking of customers, ads, and product and service purchases, both on- and off-line. This data, conveniently reported, enables businesses, advertisers, and consumers to interact more effectively.

Alternatively, a module allowing for an exact performance-based pricing system for advertising or a module to allow the replacement of paper-based coupons and rebates with a completely electronic and automated system can be installed.

The various modules of the present invention allow business and advertisers to correlate more accurately the effectiveness of particular ads in inducing particular customers to make purchases both online and offline and will thus help them target customers more effectively in the future.

### Other Mediums

While much of the discussion has been to the use of the present invention with the Internet, it can also be implemented on other mediums. For example, the present invention can be configured to radio, television and wireless networks. These new formats offer various benefits to advertisers and consumers, including allowing customers to request ads that may be viewed and/or heard on popular traditional media and allowing advertisers to target particular households rather than broad audiences.

### EXAMPLE

The notion of delayed advertising may be applicable in many different circumstances: television, web banners, multimedia presentations, radio, etc. Provided below for clarification purposes is an example of using the prevent invention to serve delayed content for Internet banner ads. Delayed advertising for banner ads on the web is the primary choice for use of the system. Before the present invention can display delayed content, the ads must be placed. An advertiser registers ads with the delay service. It places content to be displayed as delayed content. It notifies the delay service of the ads that will originate the requests for the delayed advertising and will receive a series of ids for those advertisements. Advertisements served to audience members need to be tracked and have the associated ad IDs stored so that they may be sent with the delay request for advertising.

Then, an audience member can contact a web server, through http, to request web page content. The audience member receives content in the form of content data and by following received directives to obtain content data. The primary form of interaction for a web page is the hyperlink or just link. An advertisement on the web page in the form of a graphical banner is referred to as a banner ad. Such ads almost always have a link associated with the banner to allow the audience member to obtain further information. A banner ad on a web page will have its content and links served to the audience member from a server called an ad server. The ad server need not be the web server that was originally contacted in order to generate a web page for the audience member. If the audience member activates and follows the link associated with the banner ad then the user will be required to receive further content at that time.

The link may point directly to the service that will provide the delayed advertising content, and carry with it (encoded in the URL it points to, for instance) the required information (an id for the original ad, where the ad was seen, etc.) for the delay service. The link may also point to another service that can then redirect the link to the delay service. If the audience member chooses to delay the advertisement he merely has to follow the appropriate link. The link will be designed to open a new browser window so the new content (informing the audience member of the received request for delayed advertising) will not interfere with the original web page content.

Identification of an audience member who delays an ad is needed to ensure he receives the delayed content. This identification system can be provided in multiple ways. The ID can be obtained by the ad server, and then passed on in the form of the link for the delayed service. Or the audience member can provide a unique id through a form. The most likely way to convey identification is to have the delay service give the audience member a cookie containing a unique ID. This information may be read or written to by authorized servers. The delay service will then provide the requested delayed content at a later time. One method for providing the delayed information will be a web page provided by the delay service. The audience member can visit the page at his convenience and receive the requested information. Another method would be for the information to be emailed to the audience member in a timely fashion. This method would require the delay service to know the audience member's email address and associate that information with the audience member's ID.

### Filtering

As described above, the delay service can provide filtering of the content. One such example for filtering is with HTML e-mail messages. This filtering can protect the user's privacy by filtering or removing graphic tags which could otherwise be used to track or identify the user and his or her action.

From the foregoing detailed description, it will be evident that there are a number of changes, adaptations and modifications of the present invention which come within the province of those skilled in the art. However, it is intended that all such variations not departing from the spirit of the invention be considered as within the scope thereof.

What is claimed is:

1. A method for providing delayed advertising, comprising:
a) receiving delayed content which corresponds to ad content;
b) associating an ad identifier to the delayed content;
c) storing the delayed content and the ad identifier in a database;
d) receiving a request over a network from an audience member for a delayed advertisement, wherein the audience member has been presented with the ad content, and wherein the request comprises the ad identifier and an audience identifier; and
e) transmitting the delayed content to the audience member at a later time based on the ad identifier and the audience identifier.

2. The method for providing delayed advertising from claim 1, further comprising confirming with the audience member the request for the delayed advertisement.

3. The method for providing delayed advertising from claim 1, wherein the network is the Internet.

4. The method for providing delayed advertising from claim 1, wherein the network is an interactive television network.

5. The method for providing delayed advertising from claim 1, wherein the network is a wireless network.

6. The method for providing delayed advertising from claim 1, wherein transmitting the delayed content to the audience member is via an e-mail message.

7. The method for providing delayed advertising from claim 1, wherein transmitting the delayed content to the audience member is via a web site.

8. A method for protecting privacy over a network, comprising:
a) receiving from an audience member a request for content, wherein the audience member has been presented with a form from a content provider, and wherein the request comprises an audience identifier;
b) completing the form using proxy information;
c) submitting the form to the content provider;
d) receiving from the content provider said content;
e) transmitting the content to the audience member at a later time based on the audience identifier.

9. The method for protecting privacy over a network of claim 8, further comprising filtering the content before transmitting the content to the audience member.

10. A method for protecting privacy over a network, comprising:
a) receiving from a first audience member a first request for content, wherein the first audience member has been presented with a first form from a content provider, and wherein the first request comprises a first audience identifier;
b) completing the first form using proxy information;
c) submitting the first form to the content provider;
d) receiving from the content provider said content;
e) storing the content in a database;
f) transmitting the content to the first audience member at a later time based on the first audience identifier.
g) receiving from a second audience member a second request for content, wherein the second audience member has been presented with a second form from the content provider, and wherein the second request comprises a second audience identifier;
h) retrieving said content from the database;
i) transmitting the content to the second audience member at a later time based on the second audience identifier.

11. The method for protecting privacy over a network of claim 10, further comprising filtering the content before transmitting the content to the second audience member.
